(19) United States
(12) Patent Application Publication
(10) Pub. No.: US 2023/0152677 A1
(43) Pub. Date: May 18, 2023

(54) LIGHTING DEVICE AND PROJECTION DISPLAY APPARATUS

(71) Applicant: Panasonic Intellectual Property Management Co., Ltd., Osaka (JP)

(72) Inventor: Shigekazu YAMAGISHI, Osaka (JP)

(21) Appl. No.: 18/094,026

(22) Filed: Jan. 6, 2023

Related U.S. Application Data
(63) Continuation of application No. PCT/JP2021/029329, filed on Aug. 6, 2021.

(30) Foreign Application Priority Data
Sep. 24, 2020 (JP) 2020-160046

(51) Int. Cl. G03B 21/20; G03B 21/16

(52) U.S. Cl. CPC G03B 21/2013; G03B 21/16; G03B 21/2033; G03B 21/2066

(57) ABSTRACT

A lighting device includes: a first light source unit including a plurality of laser elements and emitting a first light flux in a first direction; a second light source unit including a plurality of laser elements and being arranged to emit a second light flux in the first direction and to be spaced apart from the first light source unit by a first distance in a second direction orthogonal to the first direction; and an optical path shift optical system including: a first reflecting surface that reflects the second light flux emitted from the second light source unit toward the first light flux; and a second reflecting surface that is parallel to the first reflecting surface and reflects the second light flux reflected by the first reflecting surface to be parallel to the first light flux at a second distance shorter than the first distance.

### BACKGROUND

### 1. Technical Field

The present disclosure relates to a lighting device and a projection display apparatus including the lighting device.

### 2. Description of the Related Art

As described in Patent Literature (PTL) 1, a lighting device that is used in a projection display apparatus and illuminates high-luminance illumination light by collecting light emitted from a plurality of light sources such as an LED and a laser element at high density is known. In the case of the lighting device described in PTL 1, light fluxes from a plurality of light source units each including a plurality of light sources are densely gathered via an optical element such as a mirror, thereby realizing irradiation of high-luminance illumination light.

PTL 1 is Unexamined Japanese Patent Publication No. 2017-211603.

### SUMMARY

However, in a case where light fluxes of a plurality of light source units each including a plurality of light sources are gathered at a high density to realize irradiation of high-luminance illumination light as in the lighting device described in PTL 1, the close arrangement of the light source units may be limited depending on the size and shape of the light source unit, the optional size and shape of the light source unit such as a cooling device, and the like, thereby limiting the high-density gathering of light fluxes.

Therefore, an object of the present disclosure is to provide a lighting device including the plurality of light source units each including the plurality of laser elements, even if the close arrangement of the plurality of light source units is restricted, the light fluxes of the light source units can be gathered at high density, and the high-luminance illumination light can be illuminated.

In order to solve the above problem, according to one aspect of the present disclosure, there is provided a lighting device including:

a first light source unit including a plurality of laser elements having optical axes arranged in parallel and in a matrix, the first light source unit emitting a first light flux in a first direction;

a second light source unit including a plurality of laser elements having optical axes arranged in parallel and in a matrix, the second light source unit being arranged to emit a second light flux in the first direction and to be spaced apart from the first light source unit by a first distance in a second direction orthogonal to the first direction; and

an optical path shift optical system including: a first reflecting surface that reflects the second light flux emitted from the second light source unit toward the first light flux; and a second reflecting surface that is parallel to the first reflecting surface and reflects the second light flux reflected by the first reflecting surface to be parallel to the first light flux at a second distance shorter than the first distance.

According to another aspect of the present disclosure,

there is provided a projection display apparatus including:

a lighting unit including at least one lighting device;

an image display unit configured to modulate illumination light from the lighting unit and output the modulated illumination light as image light; and

a projection optical system configured to enlarge and project the image light. The at least one lighting device includes:

a first light source unit including a plurality of laser elements having optical axes arranged in parallel and in a matrix, the first light source unit emitting a first light flux in a first direction;

a second light source unit including a plurality of laser elements having optical axes arranged in parallel and in a matrix, the second light source unit being arranged to emit a second light flux in the first direction and to be spaced apart from the first light source unit by a first distance in a second direction orthogonal to the first direction; and

an optical path shift optical system including: a first reflecting surface that reflects the second light flux emitted from the second light source unit toward the first light flux;

and a second reflecting surface that is parallel to the first reflecting surface and reflects the second light flux reflected by the first reflecting surface to be parallel to the first light flux at a second distance shorter than the first distance.

According to the present disclosure, in the lighting device including the plurality of light source units each including the plurality of laser elements, even if the approach arrangement of the plurality of light source units is restricted, the light fluxes of the light source units can be gathered at high density, and the illumination light with high luminance can be illuminated.

### BRIEF DESCRIPTION OF THE DRAWINGS

FIG. 1 is a schematic configuration diagram of a projection display apparatus according to a first exemplary embodiment of the present disclosure.

FIG. 2 is a perspective view of a lighting device according to the first exemplary embodiment.

FIG. 3 is a front view of the lighting device according to the first exemplary embodiment.

FIG. 4 is a side view of the lighting device according to the first exemplary embodiment.

FIG. 5 is a top view of the lighting device according to the first exemplary embodiment.

FIG. 6 is a diagram illustrating an image of a first light flux and an image of a second light flux.

FIG. 7 is a front view of a lighting device in a projection display apparatus according to a second exemplary embodiment of the present disclosure.

FIG. 8 is a front view of a lighting device in a projection display apparatus according to a third exemplary embodiment of the present disclosure.

FIG. 9 is a front view of a lighting device in a projection display apparatus according to a fourth exemplary embodiment of the present disclosure.

FIG. 10 is a top view of the lighting device according to the fourth exemplary embodiment.

FIG. 11 is a front view of the lighting device in a projection display apparatus according to a fifth exemplary embodiment of the present disclosure.

FIG. 12 is a top view of the lighting device according to the fifth exemplary embodiment.

FIG. 13 is a schematic configuration diagram of a projection display apparatus according to another example 1 of the present disclosure.

FIG. 14 is a diagram illustrating images of a plurality of light fluxes.

FIG. 15 is a top view of a light source unit of another example 2.

FIG. 16 is a front view of a lighting device of another example 3 including three light source units.

### DETAILED DESCRIPTION

A lighting device according to one aspect of the present disclosure includes: a first light source unit including a plurality of laser elements having optical axes arranged in parallel and in a matrix, the first light source unit emitting a first light flux in a first direction; a second light source unit including a plurality of laser elements optical axes arranged in parallel and in a matrix, the second light source unit being arranged to emit a second light flux in the first direction and to be spaced apart from the first light source unit by a first distance in a second direction orthogonal to the first direction; and an optical path shift optical system including: a first reflecting surface that reflects the second light flux emitted from the second light source unit toward the first light flux; and a second reflecting surface that is parallel to the first reflecting surface and reflects the second light flux reflected by the first reflecting surface so as to be parallel to the first light flux at a second distance shorter than the first distance.

According to such an aspect, in the lighting device including the plurality of light source units each including the plurality of laser elements, even if the approach arrangement of the plurality of light source units is restricted, the light fluxes of the light source units can be gathered at high density, and the illumination light with high luminance can be illuminated.

For example, the optical path shift optical system may be a prism having a parallelogram shape. The prism may include the first reflecting surface, the second reflecting surface, a first transmission surface through which the second light flux emitted from the second light source unit passes, and a second transmission surface parallel to the first transmission surface and through which the second light flux reflected by the second reflecting surface passes.

For example, the optical path shift optical system may include a first mirror including the first reflecting surface and a second mirror including the second reflecting surface.

For example, each of the plurality of laser elements of each of the first and second light source units may be semiconductor laser elements, and each of the first and second light source units may include a collimating lens provided for each of the semiconductor laser elements.

For example, each of the first and second light source units may include a collimating lens array in which a plurality of collimating lenses each being the collimating lens are arranged and integrated at a same arrangement pitch as an arrangement pitch of the plurality of semiconductor laser elements.

For example, the lighting device may further include: a heat transfer plate including a first heat transfer surface to which the first and second light source units are attached and a second heat transfer surface opposite to the first heat transfer surface; and a cooling device attached to the second heat transfer surface of the heat transfer plate.

For example, the cooling device includes a first cooling device arranged to face the first light source unit with the heat transfer plate interposed between the cooling device and the first cooling device, and a second cooling device arranged to face the second light source unit with the heat transfer plate interposed between the cooling device and the second cooling device.

For example, the lighting device may further include: a first thermoelectric element including a heat absorption surface in contact with the second heat transfer surface of the heat transfer plate and a heat dissipating surface to which the first cooling device is attached; and a second thermoelectric element including a heat absorption surface in contact with the second heat transfer surface of the heat transfer plate and a heat dissipating surface to which the second cooling device is attached.

For example, as viewed in a first direction, the first light source unit may be arranged at a central portion of the heat absorption surface of the first thermoelectric element, and the second light source unit may be arranged at a central portion of the heat absorption surface of the second thermoelectric element.

For example, the heat transfer plate may include a first heat transfer plate to which the first light source unit is attached and which abuts on the first thermoelectric element, and a second heat transfer plate to which the second light source unit is attached and which abuts on the second thermoelectric element.

For example, the semiconductor laser element may emit red laser light.

A projection display apparatus according to another aspect of the present disclosure includes: a lighting unit including at least one lighting device; an image display unit configured to modulate illumination light from the lighting unit and output the modulated illumination light as image light; and a projection optical system configured to enlarge and project the image light. The lighting device includes: a first light source unit including a plurality of laser elements having optical axes arranged in parallel and in a matrix, the at least one first light source unit emitting a first light flux in a first direction; a second light source unit including a plurality of laser elements having optical axes arranged in parallel and in a matrix, the second light source unit being arranged to emit a second light flux in the first direction and to be spaced apart from the first light source unit by a first distance in a second direction orthogonal to the first direction; and an optical path shift optical system including: a first reflecting surface that reflects the second light flux emitted from the second light source unit toward the first light flux; and a second reflecting surface that is parallel to the first reflecting surface and reflects the second light flux reflected by the first reflecting surface so as to be parallel to the first light flux at a second distance shorter than the first distance.

According to such an aspect, in the lighting device of the projection display apparatus which includes the plurality of light source units each including the plurality of laser elements, even if the approach arrangement of the plurality of light source units is restricted, the light fluxes of the light source units can be gathered at high density, and the illumination light with high luminance can be illuminated.

An exemplary embodiment of the present disclosure will be described below with reference to the drawings.

### First Exemplary Embodiment

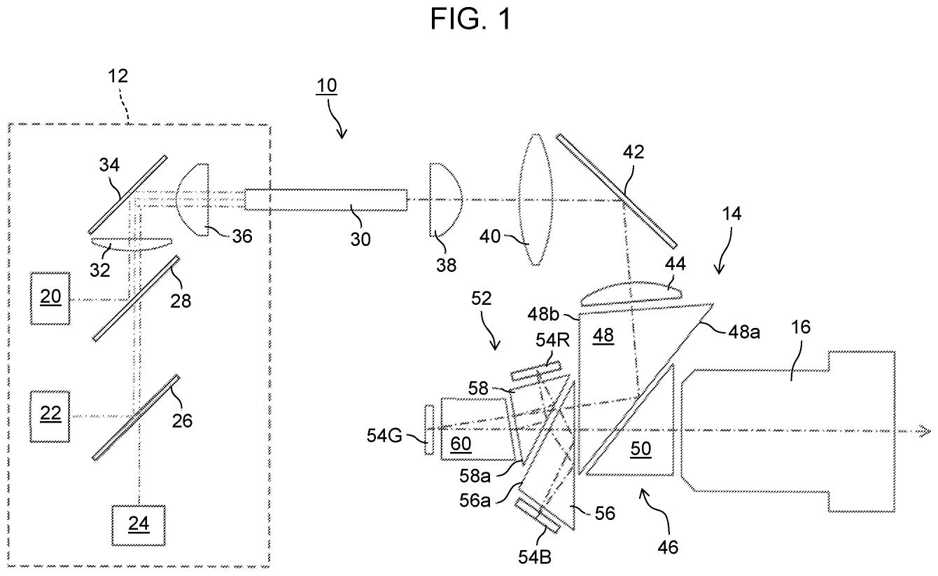

FIG. 1 is a schematic configuration diagram of a projection display apparatus according to an exemplary embodiment of the present disclosure.

As illustrated in FIG. 1, projection display apparatus 10 according to the first exemplary embodiment is a so-called DLP projector, and includes lighting unit 12, image display unit 14 that modulates at least part of illumination light from lighting unit 12 and outputs image light, and projection optical system 16 that enlarges and projects the image light output from image display unit 14.

Lighting unit 12 of projection display apparatus 10 includes lighting device 20 that emits red light, lighting device 22 that emits green light, and lighting device 24 that emits blue light. Further, lighting unit 12 includes green selective reflection mirror 26 that emits green light from lighting device 22 and blue light from lighting device 24 in a superimposed manner, red selective reflection mirror 28 that emits light emitted from green selective reflection mirror 26 and red light from lighting device 20 in a superimposed manner, and rod integrator 30 that collects the light emitted from red selective reflection mirror 28. Lighting unit 12 further includes lens 32, mirror 34, and lens 36 arranged between red selective reflection mirror 28 and rod integrator 30. Lighting devices 20, 22, 24 have substantially the same configuration except that colors of irradiation light are different, and details thereof will be described later.

The illumination light from lighting unit 12 reaches image display unit 14 via relay lenses 38, 40, mirror 42, and field lens 44.

Image display unit 14 includes total reflection prism 46 that totally reflects the illumination light from lighting unit 12. Total reflection prism 46 includes triangular prism 48 and triangular prism 50 that forms an air gap with triangular prism 48. The illumination light is totally reflected by surface 48a of triangular prism 48 in contact with the air gap, passes through surface 48b, and enters color prism unit 52.

Color prism unit 52 of image display unit 14 is configured to disperse the illumination light reflected by total reflection prism 46 into three light beams, respectively emit the dispersed light beams to the corresponding digital mirror devices (DMDs) 54R, 54G, 54B, combine the reflected light beams from DMDs 54R, 54G, 54B, and emit the combined light beams toward total reflection prism 46.

Specifically, color prism unit 52 includes first prism 56 having dichroic mirror surface 56a that reflects blue light, second prism 58 having dichroic mirror surface 58a that reflects red light and blue light, and third prism 60. An air gap for total reflection is provided between first prism 56 and second prism 58. Color prism unit 52 emits red light to DMD 54R, green light to DMD 54G, and blue light to DMD 54B.

DMDs 54R, 54G, 54B are devices having substantially the same configuration, and each of the devices schematically includes a base portion and a plurality of micromirrors provided on the base portion in a matrix form such that a slope angle can be changed in a two-alternative manner. The slope angle of the micromirror is changed on the basis of an image signal from the outside, for example, the micromirror is selectively inclined at a first slope angle at which the reflected light is incident on color prism unit 52 at an incident angle of 0 degrees and a second slope angle at which the reflected light is incident on color prism unit 52 at an angle larger than 0 degrees. With such a configuration, DMD 54R outputs at least partially modulated red light (red image light), and DMDs 54G, 54B similarly output green image light and blue image light.

The red image light, the green image light, and the blue image light from DMDs 54R, 54G, 54B are synthesized by color prism unit 52, and the synthesized image light (color image light) is emitted toward total reflection prism 46. The color image light is transmitted through total reflection prism 46, and is enlarged and projected on a screen or the like through projection optical system 16 including a projection lens or the like.

Hereinafter, lighting devices 20, 22, 24 of lighting unit 12 of projection display apparatus 10 will be described in detail. lighting devices 20, 22, 24 have substantially the same configuration except that colors of illumination light are different. Therefore, lighting device 20 will be described, and description of remaining lighting devices 22, 24 will be omitted.

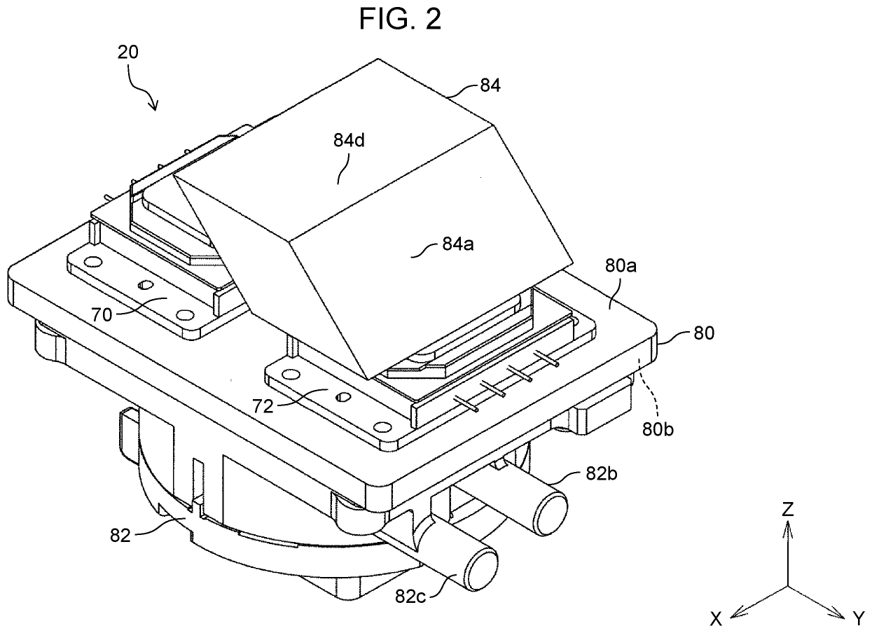

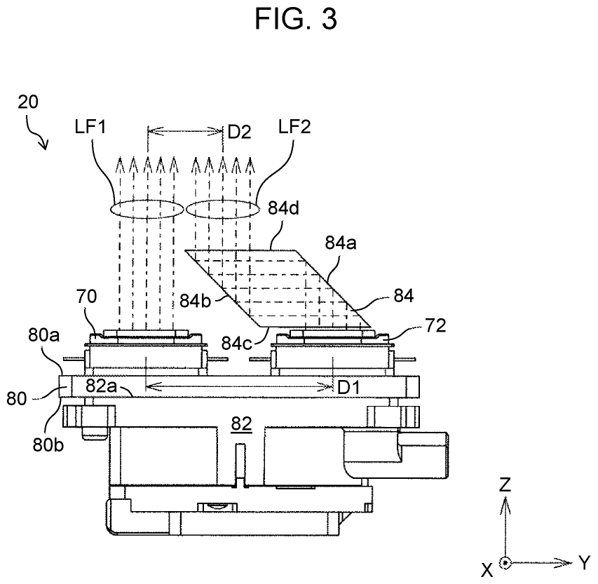

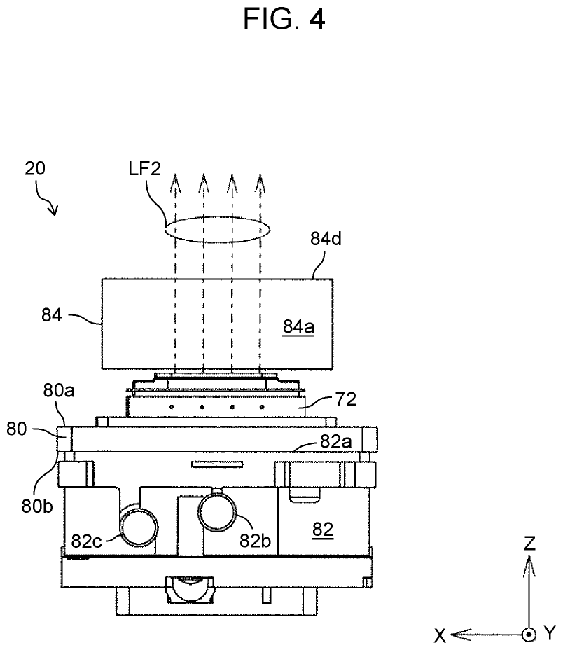

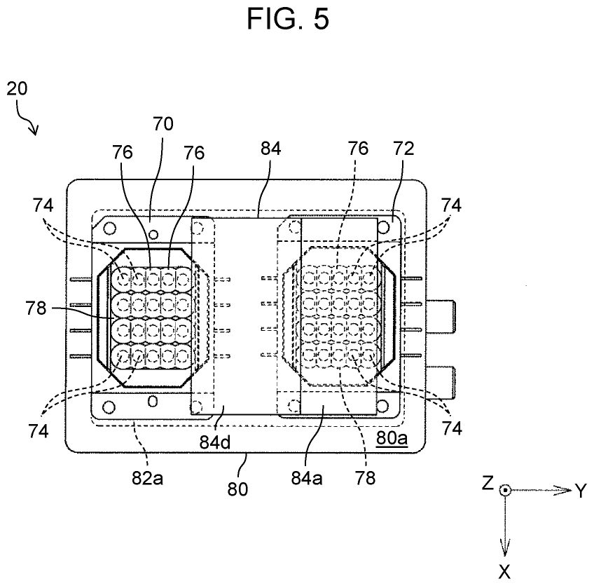

FIG. 2 is a perspective view of a lighting device according to the first exemplary embodiment. FIG. 3 is a front view of the lighting device according to the first exemplary embodiment. Further, FIG. 4 is a side view of the lighting device according to the first exemplary embodiment. FIG. 5 is a top view of the lighting device according to the first exemplary embodiment. An XYZ Cartesian coordinate system illustrated in the drawings is for facilitating understanding of the present disclosure and does not limit the exemplary embodiment. The Z-axis direction indicates the irradiation direction of the irradiation light of the lighting device.

As illustrated in FIGS. 2 and 3, lighting device 20 according to the first exemplary embodiment includes first and second light source units 70, 72. In the first exemplary embodiment, first and second light source units 70, 72 have the same configuration.

As illustrated in FIG. 5, first and second light source units 70, 72 include a plurality of laser elements 74 whose optical axes are arranged in parallel (extending in the Z-axis direction) and in a matrix (on the X-Y plane). Laser element 74 is, for example, a semiconductor laser element. In the case of the first exemplary embodiment, 20 laser elements 74 are arranged in a 5×4 matrix in each of first and second light source units 70, 72.

In the case of the first exemplary embodiment, each of first and second light source units 70, 72 is provided with laser element 74, and includes collimating lens 76 that substantially collimates the laser light from laser element 74. In the case of the first exemplary embodiment, the plurality of collimating lenses 76 are integrated to constitute collimating lens array 78. In collimating lens array 78, the plurality of collimating lenses 76 are arranged at the same arrangement pitch as the arrangement pitch of the laser elements 74.

As illustrated in FIG. 3, first and second light source units 70, 72 including the plurality of laser elements 74 emit first and second light fluxes LF1, LF2 including a plurality of parallel light beams. First and second light source units 70, 72 are arranged to emit first and second light fluxes LF1, LF2 in the same direction (Z-axis direction). In the case of the first exemplary embodiment, lighting device 20 includes heat transfer plate 80 made of a material having high thermal conductivity such as copper, and first and second light source units 70, 72 are attached to planar first heat transfer surface 80a of heat transfer plate 80 with screws.

Heat transfer plate 80 is a member for drawing heat from first and second light source units 70, 72 generated by the outputs of first and second light fluxes LF1, LF2. In order to improve heat transfer efficiency from first and second light source units 70, 72 to heat transfer plate 80, a heat transfer promotion member such as heat conductive grease may be arranged between the first and second light source units.

In the case of the first exemplary embodiment, as illustrated in FIGS. 2 to 4, lighting device 20 further includes cooling device 82 that cools heat transfer plate 80. Cooling device 82 is attached to second heat transfer surface 80b opposite to first heat transfer surface 80a to which first and second light source units 70, 72 are attached via screws or the like. In the case of the first exemplary embodiment, cooling device 82 is, for example, a device that cools a member (heat transfer plate 80 in the case of the first Exemplary Embodiment in contact with cooling surface 82a with liquid (refrigerant), and includes inlet pipe 82b into which the refrigerant flows, outlet pipe 82c from which the refrigerant flows out, and a pump (not illustrated) that generates a flow of the refrigerant. By being cooled by cooling device 82 via heat transfer plate 80, first and second light source units 70, 72 can be increased in power and life. As illustrated in FIG. 5, first and second light source units 70, 72 are preferably located within the contour of cooling surface 82a in a top view (viewed in the Z-axis direction) of lighting device 20 in consideration of cooling performance.

As illustrated in FIGS. 3 and 5, first and second light source units 70, 72 are arranged at first distance D1. Specifically, first and second light source units 70, 72 are arranged in parallel with first distance D1 in a direction (Y-axis direction) orthogonal to the emission direction (Z-axis direction) of first and second light fluxes LF1, LF2, under the restriction of the size, shape, and the like, although the first and second light source units are arranged as close as possible.

As illustrated in FIG. 3, when first and second light source units 70, 72 are arranged at first distance D1, naturally, first and second light fluxes LF1, LF2 are also emitted at first distance D1. As a result, in the image of the illumination light emitted from lighting device 20, luminance unevenness occurs in which the central portion is dark and the outer portion is bright, and the image quality is impaired. Therefore, in order to increase the density of the illumination light irradiated from lighting device 20 while suppressing the occurrence of luminance unevenness, lighting device 20 includes optical path shift optical system 84.

In the first exemplary embodiment, optical path shift optical system 84 is a parallelogram-shaped prism as illustrated in FIGS. 2 and 3. Specifically, optical path shift optical system 84 has a parallelogram shape as viewed in a direction (X-axis direction) orthogonal to the emission direction (Z-axis direction) of first and second light fluxes LF1, LF2 and the parallel direction (Y-axis direction) of first and second light source units 70, 72.

As illustrated in FIG. 3, optical path shift optical system 84 (parallelogram-shaped prism) is made of a material that can transmit light and is hardly deformed even at a high temperature, for example, glass. Optical path shift optical system 84 (prism) includes first reflecting surface 84a that reflects all of second light flux LF2 emitted from second light source unit 72 in the parallel direction (Y-axis direction) of first and second light source units 70, 72 toward first light flux LF1. Optical path shift optical system 84 (prism) includes second reflecting surface 84b that is parallel to first reflecting surface 84a and reflects second light flux LF2 reflected by first reflecting surface 84a so as to be parallel to first light flux LF1 at second distance D2 shorter than the first distance. Further, optical path shift optical system 84 (prism) includes first transmission surface 84c through which all of second light flux LF2 before being reflected by first reflecting surface 84a is transmitted, and second transmission surface 84d that is parallel to first transmission surface 84c and through which second light flux LF2 reflected by second reflecting surface 84b is transmitted. Optical path shift optical system 84 (prism) is retained by, for example, a housing (not illustrated) of lighting device 20 that holds heat transfer plate 80.

According to optical path shift optical system 84 (prism), second light flux LF2 can approach first light flux LF1 up to second distance D2 shorter than first distance D1 between first and second light source units 70, 72. As a result, first and second light fluxes LF1, LF2 gather at a high density.

First light flux LF1 is not related to optical path shift optical system 84 (prism). That is, first light flux LF1 propagates from first light source unit 70 without being reflected by optical path shift optical system 84 or passing through optical path shift optical system 84.

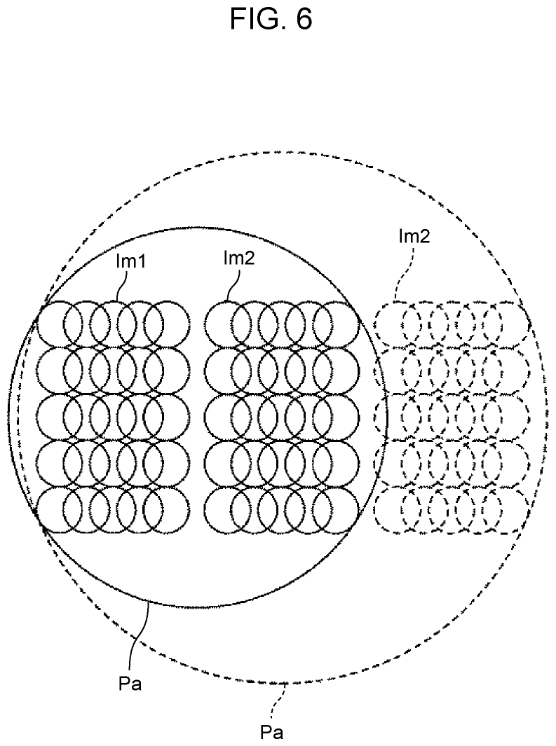

FIG. 6 is a diagram illustrating an image of a first light flux and an image of a second light flux.

As illustrated in FIG. 6, when optical path shift optical system 84 is present, image Im2 (solid line) of second light flux LF2 is closer to image Im1 of first light flux LF1 than when optical path shift optical system 84 is not present (dotted line). As a result, optical path region Pa (solid line) in lighting device 20 can be made smaller than that in the case where optical path shift optical system 84 is not present (dotted line). As a result, the illumination light of lighting device 20 is reduced in luminance unevenness and increased in density. It is also possible to downsize an optical element such as a lens in projection display apparatus 10, and as a result, it is possible to downsize projection display apparatus 10.

According to the first exemplary embodiment as described above, in the lighting device including the plurality of light source units each including the plurality of laser elements, even if the close arrangement of the plurality of light source units is restricted, the light fluxes of the light source units can be gathered at high density, and the high-luminance illumination light can be illuminated.

### Second Exemplary Embodiment

A projection display apparatus according to a second exemplary embodiment is different from the first exemplary embodiment in an optical path shift optical system in a lighting device. Therefore, the present second exemplary embodiment will be described while focusing on differences. Components in the second exemplary embodiment that are substantially identical to those in the first exemplary embodiment described above are denoted by the same reference signs.

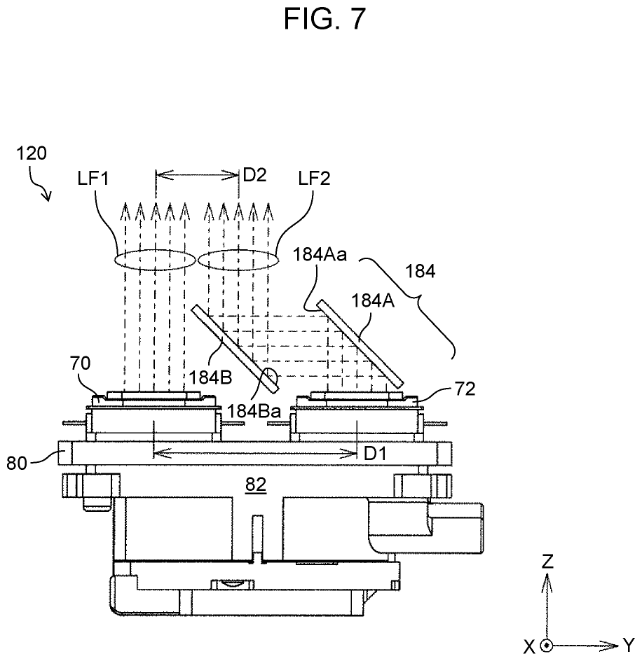

FIG. 7 is a front view of a lighting device in a projection display apparatus according to the second exemplary embodiment of the present disclosure.

As illustrated in FIG. 7, lighting device 120 according to the second exemplary embodiment includes first and second light source units 70, 72 arranged at first distance D1 as in the first exemplary embodiment. In order to bring second light flux LF2 of second light source unit 72 close to first light flux LF1 of first light source unit 70, lighting device 120 has optical path shift optical system 184.

In the second exemplary embodiment, optical path shift optical system 184 includes first and second mirrors 184A, 184B. First mirror 184A includes first reflecting surface 184Aa that reflects all of second light flux LF2 emitted from second light source unit 72 toward first light flux LF1 in the parallel direction (Y-axis direction) of first and second light source units 70, 72. Second mirror 184B includes second reflecting surface 184Ba that is parallel to first reflecting surface 184Aa of first mirror 184A and reflects second light flux LF2 reflected by first reflecting surface 184Aa to be parallel to first light flux LF1 at second distance D2 shorter than first distance D1.

According to the second exemplary embodiment as described above, similarly to the first exemplary embodiment, in the lighting device including the plurality of light source units each including the plurality of laser elements, even if the close arrangement of the plurality of light source units is restricted, the light fluxes of the light source units can be gathered at high density, and the high-luminance illumination light can be illuminated.

### Third Exemplary Embodiment

A projection display apparatus according to a third exemplary embodiment is different from that of the first exemplary embodiment in that a distance between first and second light source units in a lighting device is different, and thus a cooling device is different. Therefore, the present third exemplary embodiment will be described while focusing on differences. Components in the third exemplary embodiment that are substantially identical to those in the first exemplary embodiment described above are denoted by the same reference signs.

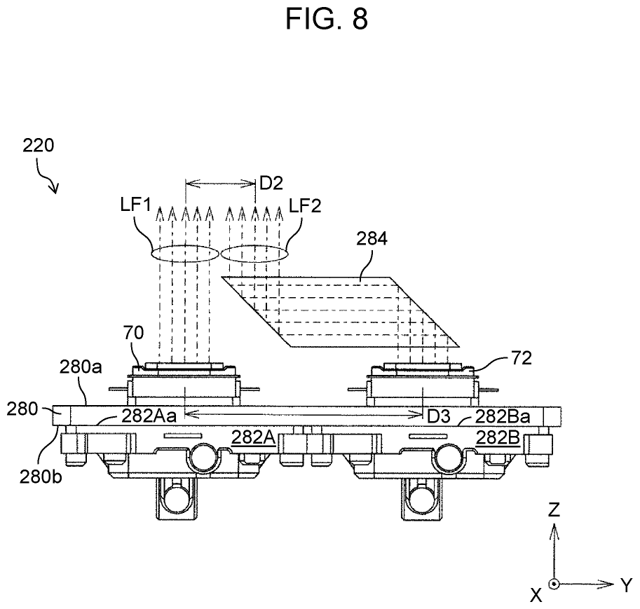

FIG. 8 is a front view of a lighting device in a projection display apparatus according to the third exemplary embodiment of the present disclosure.

As illustrated in FIG. 8, in lighting device 220 according to the third exemplary embodiment, first and second light source units 70, 72 are arranged at first distance D3 (D3>D1) larger than first distance D1 in the first exemplary embodiment. This is because the cooling device in lighting device 220 is different from the cooling device of the first exemplary embodiment.

Specifically, in the case of the above-described first exemplary embodiment, as illustrated in FIG. 3, one cooling device 82 is commonly used for first and second light source units 70, 72. On the other hand, in the case of the third exemplary embodiment, as illustrated in FIG. 8, first and second cooling devices 282A, 282B are provided in a state of being maximally close to each other with respect to first and second light source units 70, 72, respectively. First and second light source units 70, 72 are arranged on first heat transfer plate 280a of heat transfer plate 280, and first and second cooling devices 282A, 282B are arranged on second heat transfer surface 280b of heat transfer plate 280. First cooling device 282A is arranged to face first light source unit 70 with heat transfer plate 280 interposed therebetween. Second cooling device 282B is arranged to face second light source unit 72 with heat transfer plate 280 interposed therebetween.

First and second light source units 70, 72 are arranged at central portions of cooling surfaces 282Aa, 282Ba of first and second cooling devices 282A, 282B in a top view (as viewed in the Z-axis direction) of lighting device 220. As a result, first and second light source units 70, 72 are separated by first distance D3. That is, the close arrangement of first and second light source units 70, 72 is limited due to the size constraints of first and second cooling devices 282A, 282B.

Since first and second light source units 70, 72 have first distance D3 larger than first distance D1 in the first exemplary embodiment, heat transfer plate 280 and optical path shift optical system 284 (prism) are larger than heat transfer plate 80 and optical path shift optical system 84 in the first exemplary embodiment described above.

When first and second cooling devices 282A, 282B are provided for first and second light source units 70, 72, respectively, the close arrangement of first and second light source units 70, 72 is restricted. However, second light flux LF2 of second light source unit 72 can be brought close to first light flux LF1 of first light source unit 70 by optical path shift optical system 284 (prism) similarly to the first exemplary embodiment.

Since first and second cooling devices 282A, 282B are provided for first and second light source units 70, 72, respectively, cooling control of first and second light source units 70, 72 can be performed independently.

According to the third exemplary embodiment as described above, similarly to the first exemplary embodiment, in the lighting device including the plurality of light source units each including the plurality of laser elements, even if the close arrangement of the plurality of light source units is restricted, the light fluxes of the light source units can be gathered at high density, and the high-luminance illumination light can be illuminated.

### Fourth Exemplary Embodiment

The present fourth exemplary embodiment is an improvement of the third exemplary embodiment described above. The fourth exemplary embodiment will now be described while focusing on the third exemplary embodiments. Components in the fourth exemplary embodiment that are substantially identical to those in the third exemplary embodiment described above are denoted by the same reference signs.

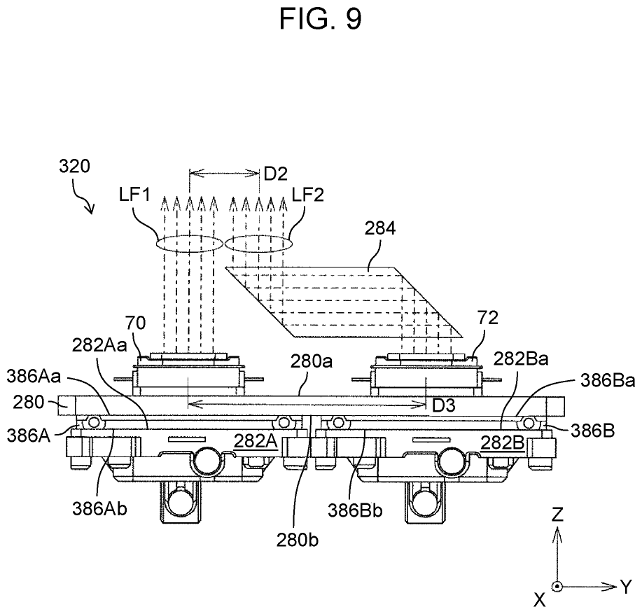

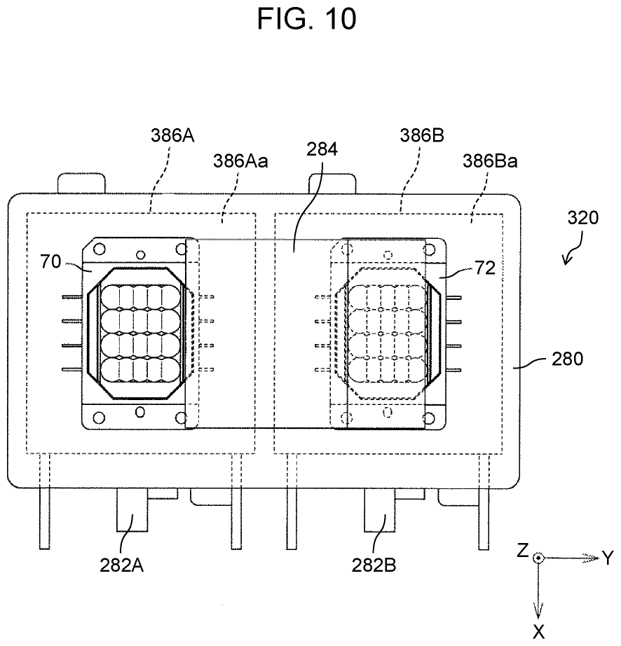

FIG. 9 is a front view of a lighting device in a projection display apparatus according to the fourth exemplary embodiment of the present disclosure. FIG. 10 is a top view of the lighting device according to the fourth exemplary embodiment.

As illustrated in FIGS. 9 and 10, lighting device 320 according to the fourth exemplary embodiment includes first thermoelectric element 386A and second thermoelectric element 386B.

First and second thermoelectric elements 386A, 386B are, for example, Peltier elements, and include heat absorption surfaces 386Aa, 386Ba that absorb heat of a cooling target (first and second light source units 70, 72 in the case of the present fourth exemplary embodiment) and heat dissipating surfaces 386Ab, 386Bb that release the absorbed heat.

Specifically, first thermoelectric element 386A is arranged between heat transfer plate 280 and first cooling device 282A. Heat absorption surface 386Aa of first thermoelectric element 386A abuts on second heat transfer surface 280b of heat transfer plate 280, and heat dissipating surface 386Ab abuts on cooling surface 282Aa of first cooling device 282A. Specifically, as illustrated in FIG. 10, heat absorption surface 386Aa overlaps first light source unit 70 in a top view (viewed in the Z-axis direction) of lighting device 320.

Second thermoelectric element 386B is arranged between heat transfer plate 280 and second cooling device 282B. Heat absorption surface 386Ba of second thermoelectric element 386B abuts on second heat transfer surface 280b of heat transfer plate 280, and heat dissipating surface 386Bb abuts on cooling surface 282Ba of second cooling device 282B. Specifically, as illustrated in FIG. 10, heat absorption surface 386Ba overlaps second light source unit 72 in a top view (viewed in the Z-axis direction) of lighting device 320.

Such first and second thermoelectric elements 386A, 386B cool (absorb heat) first and second light source units 70, 72 via heat transfer plate 280. Through cooling, heat dissipating surfaces 386Ab, 386Bb of first and second thermoelectric elements 386A, 386B heated to high temperatures are cooled by first and second cooling devices 282A, 282B.

Thus, the temperatures of first and second light source units 70, 72 can be finely controlled by controlling the drive currents supplied to first and second thermoelectric elements 386A, 386B. For example, in a case where a red semiconductor laser element is used as a laser element of each of first and second light source units 70, 72, the output, wavelength, and lifetime of the red semiconductor laser element change depending on the temperature. Therefore, temperature control is performed by first and second thermoelectric elements 386A, 386B in order to maintain the temperature constant.

As illustrated in FIG. 10, in the case of the fourth exemplary embodiment, heat absorption surfaces 386Aa, 386Ba of first and second thermoelectric elements 386A, 386B are sufficiently larger than those of first and second light source units 70, 72 in a top view (viewed in the Z-axis direction) of lighting device 320. In this case, in a top view, first and second light source units 70, 72 are preferably arranged at the central portions of the heat absorption surfaces 386Aa, 386Ba.

In contrast, when first and second light source units 70, 72 are arranged in the vicinity of the outer peripheries of heat absorption surfaces 386Aa, 386Ba in a top view (viewed in the Z-axis direction) of lighting device 320, there is a possibility that dew condensation occurs in a portion of heat transfer plate 280 facing the portion of the heat absorption surfaces 386Aa, 386Ba away from first and second light source units 70, 72. That is, in heat transfer plate 280 cooled by first and second thermoelectric elements 386A, 386B, there is a possibility that dew condensation occurs at a portion away from first and second light source units 70, 72 as a heat source. In order to suppress the generation of such dew condensation, it is preferable that first and second light source units 70, 72 are arranged at the central portions of the heat absorption surfaces 386Aa, 386Ba of the first and second thermoelectric elements 386A, 386B in a top view of lighting device 320.

As described above, when first and second light source units 70, 72 are arranged at the central portions of heat absorption surfaces 386Aa, 386Ba of first and second thermoelectric elements 386A, 386B in a top view (viewed in the Z-axis direction) of lighting device 320, the close arrangement of first and second light source units 70, 72 is restricted. However, second light flux LF2 of second light source unit 72 can be brought close to first light flux LF1 of first light source unit 70 by optical path shift optical system 284 (prism) similarly to the first exemplary embodiment.

According to the fourth exemplary embodiment as described above, similarly to the first exemplary embodiment, in the lighting device including the plurality of light source units each including the plurality of laser elements, even if the close arrangement of the plurality of light source units is restricted, the light fluxes of the light source units can be gathered at high density, and the high-luminance illumination light can be illuminated.

### Fifth Exemplary Embodiment

The present fifth exemplary embodiment is an improvement of the fourth exemplary embodiment described above. The fifth exemplary embodiment will now be described while focusing on the differences from the third exemplary embodiments. Components in the fifth exemplary embodiment that are substantially identical to those in the fourth exemplary embodiment described above are denoted by the same reference signs.

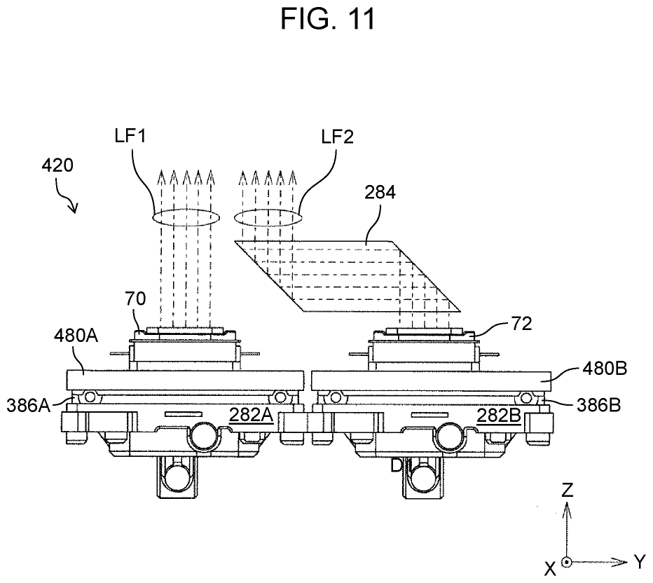

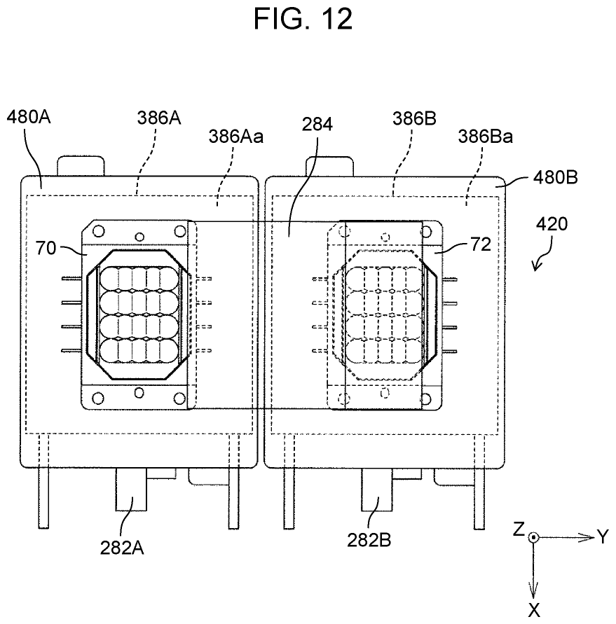

FIG. 11 is a front view of a lighting device in a projection display apparatus according to the fifth exemplary embodiment of the present disclosure. FIG. 12 is a top view of the lighting device according to the present fifth exemplary embodiment.

As illustrated in FIGS. 11 and 12, lighting device 420 according to the fifth exemplary embodiment is different from lighting device 320 according to the above-described fourth exemplary embodiment illustrated in FIGS. 9 and 10 in that first and second heat transfer plates 480A, 480B are provided for first and second light source units 70, 72, respectively.

Specifically, lighting device 420 according to the fifth exemplary embodiment includes first heat transfer plate 480A to which first light source unit 70 is attached and which is in contact with first thermoelectric element 386A, and second heat transfer plate 480B to which second light source unit 72 is attached and which is in contact with second thermoelectric element 386B.

First and second heat transfer plates 480A, 480B are separately provided for first and second light source units 70, 72, respectively, so that two thermally separated units are configured. One of the units includes first light source unit 70, first heat transfer plate 480A, first thermoelectric element 386A, and first cooling device 282A. The other unit includes second light source unit 72, second heat transfer plate 480B, second thermoelectric element 386B, and second cooling device 282B. As described above, by unitizing one light source unit, one heat transfer plate, one thermoelectric element, and one cooling device, the lighting device can be easily manufactured, and the lighting devices having different numbers of light source units can be easily constructed. Since the light source units are thermally separated, the temperature of each of the plurality of light source units can be easily controlled with high accuracy.

According to the fifth exemplary embodiment as described above, similarly to the first exemplary embodiment, in the lighting device including the plurality of light source units each including the plurality of laser elements, even if the close arrangement of the plurality of light source units is restricted, the light fluxes of the light source units can be gathered at high density, and the high-luminance illumination light can be illuminated.

Although the present disclosure has been described above by taking the above first to fifth exemplary embodiments as an example, the present disclosure is not limited to the above exemplary embodiments.

For example, as illustrated in FIG. 1, in the case of the above-described first exemplary embodiment, projection display apparatus 10 is a DLP projector, but is not limited thereto. The projection display apparatus according to the exemplary embodiment of the present disclosure is not a DLP projector but a 3LCD (liquid crystal display) projector.

In the case of the above-described first exemplary embodiment, lighting unit 12 of projection display apparatus 10 includes three lighting devices 20, 22, 24. However, the exemplary embodiment of the present disclosure is not limited thereto.

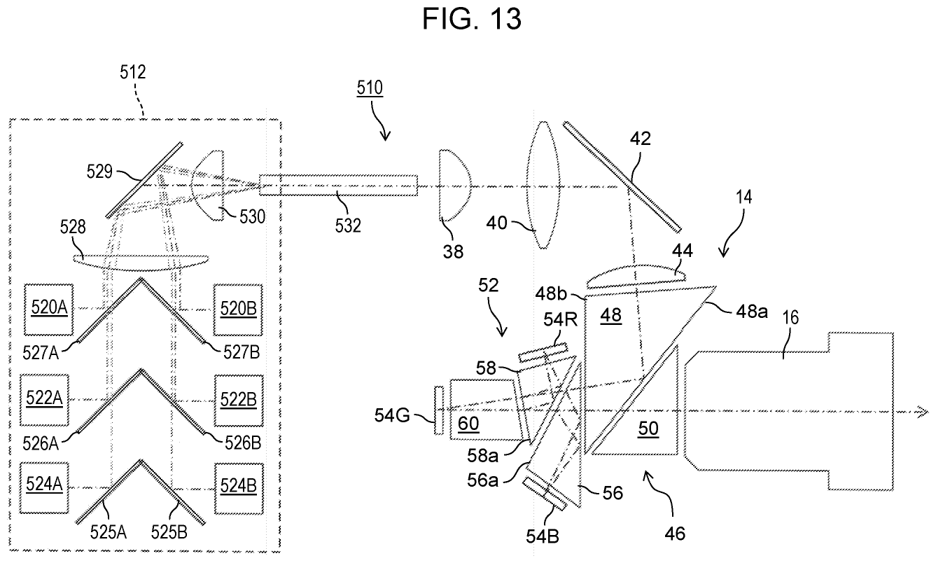

FIG. 13 is a schematic configuration diagram of a projection display apparatus according to another example 1 of the present disclosure.

In projection display apparatus 510 illustrated in FIG. 13, lighting unit 512 includes two lighting devices 520A, 520B that emit red light, two lighting devices 522A, 522B that emit green light, and two lighting devices 524A, 524B that emit blue light.

The blue light from two lighting devices 524A, 524B is reflected by mirrors 525A, 525B, transmitted through green selective reflection mirrors 526A, 526B and red selective reflection mirrors 527A, 527B, transmitted through lens 528, mirror 529, and lens 530, and incident on rod integrator 532.

The green light from the two lighting devices 522A, 522B is reflected by green selective reflection mirrors 526A, 526B, transmitted through red selective reflection mirrors 527A, 527B, transmitted through lens 528, mirror 529, and lens 530, and incident on rod integrator 532.

Then, the red light from the two lighting devices 520A, 520B is reflected by red selective reflection mirrors 527A, 527B, transmitted through lens 528, mirror 529, and lens 530, and incident on rod integrator 532.

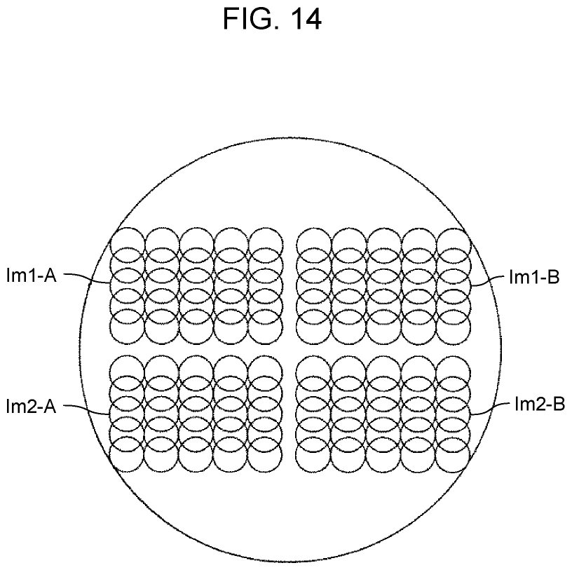

FIG. 14 illustrates images of light fluxes from two lighting devices.

As illustrated in FIG. 14, for example, image Im1-A of the first light flux of the first light source unit in lighting device 520A, image Im2-A of the second light flux of the second light source unit in lighting device 520A, image Im1-B of the first light flux of the first light source unit in lighting device 520B, and image Im2-B of the second light flux of the second light source unit in lighting device 520B constitute a red light image.

In this case, as compared with projection display apparatus 10 illustrated in FIG. 1, since the number of light source units used for irradiation with the illumination light of each color is doubled, the luminance is improved.

Further, in the exemplary embodiment of the present disclosure, the light source unit is not limited to first and second light source units 70, 72 in the above-described first to fifth exemplary embodiments.

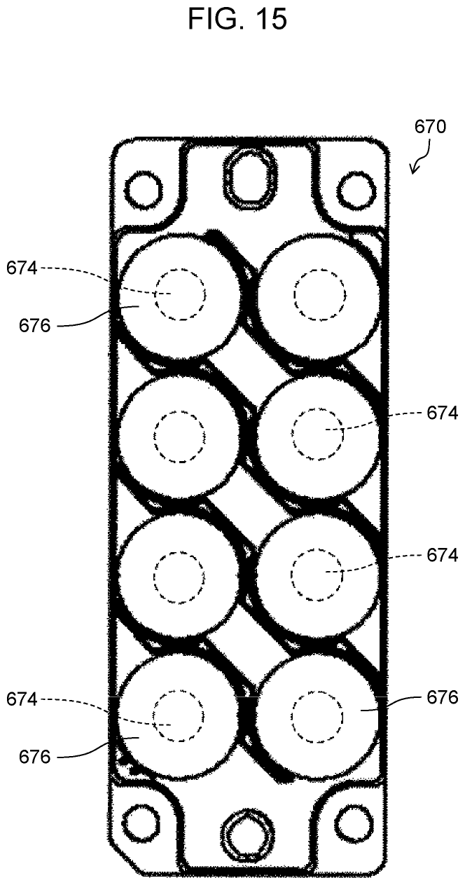

FIG. 15 is a top view of a light source unit of another example 2.

Light source unit 670 of another example 2 illustrated in FIG. 15 includes eight laser elements 674 arranged in a matrix. Collimating lens 676 is provided in each of laser elements 674. In light source unit 670, the plurality of collimating lenses 676 are not integrated. It is needless to say that in the laser element 674, similarly to laser element 74, when a plurality of laser elements are arranged, the emitted light can be arranged at high density using the present disclosure.

Further, in the case of the above-described first exemplary embodiment, the number of light source units included in lighting device 20 is two, but the embodiment of the present disclosure is not limited thereto.

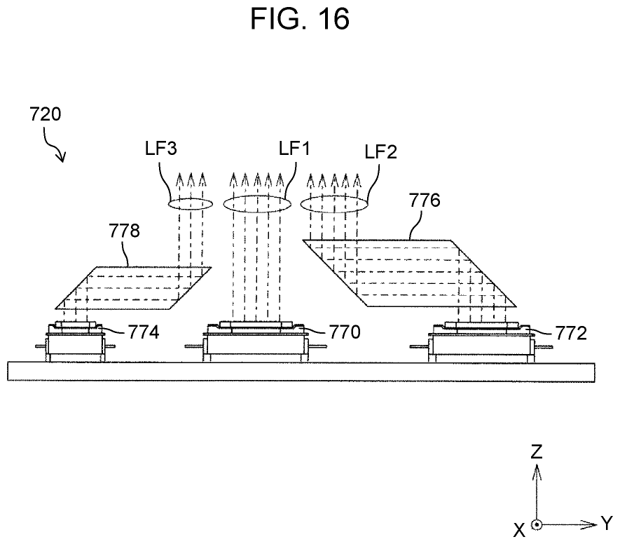

FIG. 16 is a front view of a lighting device including three light source units according to another example 3. In FIG. 16, a cooling device and a thermoelectric element are omitted.

As illustrated in FIG. 16, lighting device 720 includes first to third light source units 770, 772, 774. Lighting device 720 includes first optical path shift optical system 776 for causing second light flux LF2 of second light source unit 772 to approach first light flux LF1 of first light source unit 770. Further, lighting device 720 includes second optical path shift optical system 778 for causing third light flux LF3 of third light source unit 774 to approach first light flux LF1. As illustrated in FIG. 16, each of the plurality of light source units included in the lighting device may have a different configuration, for example, a different number of laser elements.

In the above-described exemplary embodiment, an example has been described in which the second light flux reflected by the first reflecting surface of the optical path shift optical system travels in the Y-axis direction (second direction) toward the first light flux, but the second light flux may not be strictly reflected in the Y-axis direction as long as the second light flux is reflected toward the first light flux, that is, in a direction approaching the first light flux. The second light flux reflected by the first reflecting surface may advance toward the first light flux such that a distance (second distance) between the first light flux and the second light flux is shorter than a distance (first distance) between the first light source unit and the second light source unit.

That is, in a broad sense, the lighting device according to the exemplary embodiment of the present disclosure includes: a first light source unit including a plurality of laser elements having optical axes arranged in parallel and in a matrix, the first light source unit emitting a first light flux in a first direction (Z-axis direction); a second light source unit including a plurality of laser elements having optical axes arranged in parallel and in a matrix, the second light source unit being arranged to emit a second light flux in the first direction and to be spaced apart from the first light source unit by a first distance in a second direction (Y-axis direction) orthogonal to the first direction; and an optical path shift optical system including: a first reflecting surface that reflects all the second light flux emitted from the second light source unit toward the first light flux; and a second reflecting surface that is parallel to the first reflecting surface and reflects the second light flux reflected by the first reflecting surface to be parallel to the first light flux at a second distance shorter than the first distance.

Further, in a broad sense, the projection display apparatus according to the exemplary embodiment of the present disclosure includes: a lighting unit including at least one lighting device; an image display unit configured to modulate illumination light from the lighting unit and output the modulated illumination light as image light; and a projection optical system configured to enlarge and project the image light. The at least one lighting device includes: a first light source unit including a plurality of laser elements having optical axes arranged in parallel and in a matrix, the first light source unit emitting a first light flux in a first direction (Z-axis direction); a second light source unit including a plurality of laser elements having optical axes arranged in parallel and in a matrix, the second light source unit being arranged to emit a second light flux in the first direction and to be spaced apart from the first light source unit by a first distance in a second direction (Y-axis direction) orthogonal to the first direction; and an optical path shift optical system including: a first reflecting surface that reflects all the second light flux emitted from the second light source unit toward the first light flux; and a second reflecting surface that is parallel to the first reflecting surface and reflects the second light flux reflected by the first reflecting surface to be parallel to the first light flux at a second distance shorter than the first distance.

As described above, the above exemplary embodiment has been described as examples of the techniques in the present disclosure. To this end, the drawings and detailed description are provided. Thus, in order to exemplify the above-described techniques, the components illustrated in the drawings and described in the detailed description include not only components essential for solving the problem but also components not essential for solving the problem. Therefore, the fact that such non-essential components are illustrated in the drawings or described in the detailed description should not immediately determine that these non-essential components are essential.

Since the above-described exemplary embodiment is intended to exemplify the technique according to the present disclosure, various modifications, replacements, additions, and omissions can be made within the scope of the appended claims or of their equivalents.

The present disclosure is applicable to a lighting device used in a projection display apparatus.

What is claimed is:

1. A lighting device comprising:
a first light source unit including a plurality of laser elements having optical axes arranged in parallel and in a matrix, the first light source unit emitting a first light flux in a first direction;
a second light source unit including a plurality of laser elements having optical axes arranged in parallel and in a matrix, the second light source unit being arranged to emit a second light flux in the first direction and to be spaced apart from the first light source unit by a first distance in a second direction orthogonal to the first direction; and
an optical path shift optical system including
a first reflecting surface that reflects the second light flux emitted from the second light source unit toward the first light flux, and
a second reflecting surface that is parallel to the first reflecting surface and reflects the second light flux reflected by the first reflecting surface to be parallel to the first light flux at a second distance shorter than the first distance.

2. The lighting device according to claim 1, wherein
the optical path shift optical system is a prism having a parallelogram shape, and
the prism includes the first reflecting surface, the second reflecting surface, a first transmission surface through which the second light flux emitted from the second light source unit passes, and a second transmission surface parallel to the first transmission surface and through which the second light flux reflected by the second reflecting surface passes.

3. The lighting device according to claim 1, wherein the optical path shift optical system includes a first mirror including the first reflecting surface and a second mirror including the second reflecting surface.

4. The lighting device according to claim 1, wherein
each of the plurality of laser elements of each of the first and second light source units is a semiconductor laser element, and
each of the first and second light source units includes a collimating lens provided for the semiconductor laser element.

5. The lighting device according to claim 4, wherein each of the first and second light source units includes a collimating lens array in which a plurality of collimating lenses each being the collimating lens are arranged and integrated at a same arrangement pitch as an arrangement pitch of the plurality of semiconductor laser elements.

6. The lighting device according to claim 5, further comprising:
a heat transfer plate including a first heat transfer surface to which the first and second light source units are attached and a second heat transfer surface opposite to the first heat transfer surface; and
a cooling device attached to the second heat transfer surface of the heat transfer plate.

7. The lighting device according to claim 6, wherein the cooling device includes a first cooling device arranged to face the first light source unit with the heat transfer plate interposed between the cooling device and the first cooling device, and a second cooling device arranged to face the second light source unit with the heat transfer plate interposed between the cooling device and the second cooling device.

8. The lighting device according to claim 7, further comprising:
a first thermoelectric element including a heat absorption surface in contact with the second heat transfer surface of the heat transfer plate and a heat dissipating surface to which the first cooling device is attached; and
a second thermoelectric element including a heat absorption surface in contact with the second heat transfer surface of the heat transfer plate and a heat dissipating surface to which the second cooling device is attached.

9. The lighting device according to claim 8, wherein, as viewed in a first direction, the first light source unit is arranged at a central portion of the heat absorption surface of the first thermoelectric element, and the second light source unit is arranged at a central portion of the heat absorption surface of the second thermoelectric element.

10. The lighting device according to claim 8, wherein the heat transfer plate includes a first heat transfer plate to which the first light source unit is attached and which abuts on the first thermoelectric element, and a second heat transfer plate to which the second light source unit is attached and which abuts on the second thermoelectric element.

11. The lighting device according to claim 8, wherein the semiconductor laser element emits red laser light.

12. A projection display apparatus comprising:
a lighting unit including at least one lighting device;
an image display unit configured to modulate illumination light from the lighting unit and output the modulated illumination light as image light; and
a projection optical system configured to enlarge and project the image light, wherein the at least one lighting device includes
a first light source unit including a plurality of laser elements having optical axes arranged in parallel and in a matrix, the first light source unit emitting a first light flux in a first direction,
a second light source unit including a plurality of laser elements having optical axes arranged in parallel and in a matrix, the second light source unit being arranged to emit a second light flux in the first direction and to be spaced apart from the first light source unit by a first distance in a second direction orthogonal to the first direction, and
an optical path shift optical system including
a first reflecting surface that reflects the second light flux emitted from the second light source unit toward the first light flux, and
a second reflecting surface that is parallel to the first reflecting surface and reflects the second light flux reflected by the first reflecting surface to be parallel to the first light flux at a second distance shorter than the first distance.
